(19) United States
(12) Patent Application Publication
(10) Pub. No.: US 2025/0329023 A1
(43) Pub. Date: Oct. 23, 2025

(54) IMAGE SEGMENTATION METHOD AND APPARATUS, ELECTRONIC DEVICE, AND STORAGE MEDIUM

(71) Applicant: Beijing Zitiao Network Technology Co., Ltd., Beijing (CN)

(72) Inventor: Yuanlue ZHU, Beijing (CN)

(21) Appl. No.: 18/861,538

(22) PCT Filed: Mar. 10, 2023
(86) PCT No.: PCT/CN2023/080694

§ 371 Date: Oct. 29, 2024

(30) Foreign Application Priority Data
Apr. 29, 2022 (CN) 202210475990.9

(51) Int. Cl. G06T 7/10; G06T 7/70

(52) U.S. Cl. CPC G06T 7/10; G06T 7/70; G06T 2207/20081

(57) ABSTRACT

The present disclosure provides an image segmentation method and apparatus, an electronic device, and a storage medium. The image segmentation method including: obtaining an image to be segmented; determining a preliminarily segmented image and a target normal vector image that are corresponding to the image to be segmented; and performing image fusion on the preliminarily segmented image and the target normal vector image to obtain a target segmented image.

The present disclosure claims the priority to Chinese patent application No. 202210475990.9, filed in the Chinese Patent Office on Apr. 29, 2022, which is incorporated herein by reference in its entirety.

### TECHNICAL FIELD

Embodiments of the present disclosure relate to the image processing technology, e.g., to an image segmentation method and apparatus, an electronic device, and a storage medium.

### BACKGROUND

At present, image segmentation may be realized by a deep learning algorithm based on a convolutional neural network, or may be realized by a traditional algorithm based on edge detection and plane estimation information.

However, the deep learning algorithm based on the convolutional neural network may have the problem of a poor segmentation effect due to partially missed segmentation. The traditional algorithm based on edge detection and plane estimation information imposes a high requirement on a segmented image (for example, a segmented portion of the segmented image is smooth, etc.), making it difficult to reasonably segment a segmented image with blurred edges or irregular edges.

### SUMMARY

The disclosure provides an image segmentation method and apparatus, an electronic device, and a storage medium to improve the accuracy and stability of image segmentation.

In a first aspect, the embodiments of the present disclosure provide an image segmentation method, which includes:
obtaining an image to be segmented;
determining a preliminarily segmented image and a target normal vector image that are corresponding to the image to be segmented; and
performing image fusion on the preliminarily segmented image and the target normal vector image to obtain a target segmented image.

In a second aspect, the embodiments of the present disclosure provide an image segmentation apparatus, which includes:
an obtaining module, configured to obtain an image to be segmented;
a processing module, configured to determine a preliminarily segmented image and a target normal vector image that are corresponding to the image to be segmented; and
a fusion module, configured to perform image fusion on the preliminarily segmented image and the target normal vector image to obtain a target segmented image.

In a third aspect, the embodiments of the present disclosure provide an electronic
device, which includes:
a processor; and
a storage apparatus, configured to store a program,
where the program, when executed by a processor, causes the processor to implement the image segmentation method according to any one of embodiments of the present disclosure.

In a fourth aspect, the embodiments of the present disclosure provide a storage medium including computer-executable instructions, where the computer-executable instructions, when executed by a computer processor, cause implementing the image segmentation method according to any one of embodiments of the present disclosure.

### BRIEF DESCRIPTION OF DRAWINGS

Identical or similar reference numerals indicate identical or similar elements throughout the drawings. It will be understood that the drawings are illustrative, and components and elements are not necessarily drawn to scale.

FIG. 1 is a flowchart of an image segmentation method provided by an embodiment of the present disclosure;

FIG. 2 is a flowchart of another image segmentation method provided by an embodiment of the present disclosure;

FIG. 3 is a flowchart of another image segmentation method provided by an embodiment of the present disclosure;

FIG. 4 is a flowchart of another image segmentation method provided by an embodiment of the present disclosure;

FIG. 5 is a structural schematic diagram of an image segmentation apparatus provided by an embodiment of the present disclosure; and

FIG. 6 is a structural schematic diagram of an electronic device provided by an embodiment of the present disclosure.

### DETAILED DESCRIPTION

Embodiments of the present disclosure will be described below with reference to the drawings. While some embodiments of the present disclosure are shown in the drawings, it should be understood that the present disclosure may be embodied in various forms and should not be construed as limited to the embodiments set forth herein. It should be understood that the drawings and embodiments of the present disclosure are only for exemplary purposes.

It should be understood that the various steps described in the method embodiments of the present disclosure may be performed in different orders and/or in parallel. Furthermore, the method embodiments may include additional steps and/or omit performing the illustrated steps.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

It will be understood that before using the technical solutions disclosed in various embodiments of the present disclosure, a user should be notified of a type, a range of use, a usage scenario and the like of personal information involved in the present disclosure in an appropriate manner in accordance with relevant laws and regulations, and these should be authorized by the user.

For example, in response to receiving an active request from a user, a prompt message is sent to the user to explicitly prompt the user that the operation the user requests to perform will require to acquire and use the personal information of the user. Thus, the user can independently select, according to the prompt message, whether or not to provide the personal information to software or hardware such as an electronic device, an application, a server or a memory medium that performs the operations of the technical solutions of the present disclosure.

As an optional implementation, in response to receiving an active request from a user, a manner of sending a prompt message to the user may be, for example, using a pop-up window in which the prompt message may be presented in the form of text. Furthermore, the pop-up window may also carry option controls for a user to select to “agree” or “disagree” with providing personal information to an electronic device.

It will be understood that the processes of notifying of and authorizing by a user described above are merely exemplary and do not constitute a limitation on the implementations of the present disclosure, and other manners meeting relevant laws and regulations may also be applied to the implementations of the present disclosure.

It will be understood that data (including data itself, and the acquisition and use of data) involved in the present technical solutions should follow corresponding laws and regulations and requirements of relevant stipulations.

FIG. 1 is a flowchart of an image segmentation method provided by an embodiment of the present disclosure. The embodiment of the present disclosure is applicable to a scenario of performing image segmentation on a predetermined portion to be segmented of an image. The image segmentation method may be performed by an image segmentation apparatus that may be implemented in the form of software and/or hardware and optionally implemented by an electronic device. The electronic device may be a mobile terminal, a personal computer (PC), a server, or the like.

As shown in FIG. 1, the method includes:

S110: obtaining an image to be segmented.

The image to be segmented may be an image having a portion to be segmented, where the portion to be segmented may be a portion needing to be segmented. For example, the portion to be segmented may be a floor, a wall, a ceiling, etc.

Exemplarily, the image to be segmented may be obtained from a shooting apparatus. The image to be segmented may also be obtained by uploading or downloading by a user and the like. A way of obtaining the image to be segmented may be set according to an actual situation.

Optionally, the image to be segmented may also be a video frame to be segmented in a video, e.g., each frame or part of frames in the video. Exemplarily, obtaining the image to be segmented may include obtaining a target video frame in a target video and taking the target video frame as the image to be segmented. For example, obtaining the target video frame in the target video may include: obtaining a video frame in the target video frame by frame as the target video frame, or obtaining a video frame in the target video at intervals of a preset number of video frames as the target video frame, or obtaining a video frame in the target video at intervals of a preset duration as the target video frame, or obtaining a video frame including a target object in the target video as the target video frame.

S120: determining a preliminarily segmented image and a target normal vector image that are corresponding to the image to be segmented.

The preliminarily segmented image may be a segmented image obtained by preliminarily segmenting the image to be segmented. The preliminarily segmented image includes a portion to be segmented that is roughly segmented. The preliminarily segmented image may be an image obtained by performing segmentation processing on the image to be segmented based on a segmentation model, or may be an image obtained by performing calculation on the image to be segmented based on an image segmentation algorithm. The target normal vector image may be an image obtained by extracting a normal vector from the image to be segmented. The target normal vector image may be an image obtained based on a normal vector extraction model or a normal vector calculation method. The normal vector extraction model may be trained based on a sample segmented image and a sample normal vector image corresponding to the sample segmented image.

It needs to be noted that a pixel value of each pixel in the normal vector image characterizes a normal vector corresponding to the pixel in the image to be segmented corresponding to the normal vector image. The normal vector may be a value obtained based on normal assisted stereo depth estimation, or may be obtained based on other normal vector determination ways.

Exemplarily, after the image to be segmented is obtained, preliminary segmentation processing may be performed on the image to be segmented to obtain the preliminarily segmented image, and normal vector extraction processing may be performed on the image to be segmented to obtain the target normal vector image. Alternatively, an overall image processing model is pre-trained to preliminarily extract a segmented image and a normal vector image, and the image to be segmented is processed by the overall image processing model to obtain the preliminarily segmented image and the target normal vector image.

S130: performing image fusion on the preliminarily segmented image and the target normal vector image to obtain a target segmented image.

The target segmented image may be a finally obtained segmented image that is segmented to obtain the portion to be segmented.

Exemplarily, a corresponding weight of each pixel may be determined based on the obtained target normal vector image, and then a pixel value of each pixel in the preliminarily segmented image may be weighted based on the corresponding weight of each pixel so that a weighted segmented image can be obtained. The weighted segmented image is the target segmented image.

Optionally, image fusion may be performed on the preliminarily segmented image and the target normal vector image to obtain the target segmented image by the following steps.

Step 1: for each pixel in the preliminarily segmented image, determining a predicted weight of the pixel based on a predicted pixel value of the pixel in the target normal vector image, and a preset segmentation threshold.

The preset segmentation threshold may be a threshold used to identify a normal vector of the portion to be segmented. The predicted pixel value may be a value at a corresponding pixel in a preset channel in the target normal vector image. The predicted weight may be obtained by calculating with the predicted pixel value and the preset segmentation threshold, and the predicted weight is a weight for subsequently weighting the pixel value of each pixel in an initially segmented image. For example, the predicted weight may be a quotient of the predicted pixel value and the preset segmentation threshold.

Exemplarily, for each pixel in the preliminarily segmented image, the predicted pixel value corresponding to each pixel in the target normal vector image is determined. The predicted weight of each pixel is calculated based on the predicted pixel value of each pixel and the preset segmentation threshold and is used for subsequently weighting the pixel value of each pixel in the initially segmented image.

Step 2: weighting a pixel value of the pixel in the preliminarily segmented image based on the predicted weight to obtain a target pixel value of the pixel.

The target pixel value may be a product of the pixel value in the preliminarily segmented image and the predicted weight.

Exemplarily, for each pixel in the preliminarily segmented image, the product of the pixel value of the pixel in the preliminarily segmented image and the predicted weight is taken as the target pixel value of the pixel.

Step 3: determining the target segmented image based on the target pixel value of each pixel in the preliminarily segmented image.

Exemplarily, the target pixel value of each pixel in the preliminarily segmented image is integrated according to the position of each pixel so that the target segmented image can be obtained.

Exemplarily, the portion to be segmented is a floor portion, and the target normal vector image is a three-channel image. For a second channel value of the target normal vector image, it is usually 255 for the floor and usually 0 for the ceiling. Therefore, the preliminarily segmented image of the floor may be processed based on this information to reduce the ceiling portion that is segmented as the floor portion. The preset segmentation threshold may be threshold=140.0. The target segmented image may be determined according to the following formula:

$$refined\_mask = ground\_mask * ( pred\_normal / threshold )$$

where refined_mask represents the target segmented image before standardization, ground_mask represents the preliminarily segmented image, pred_normal represents the second channel value in the target normal vector image, and threshold is the preset segmentation threshold.

Thus, refined_mask may be standardized to define the value of refined_mask within [0, 255] such that the pixel value of each pixel in the target segmented image is assigned to be between 0 and 255.

In consideration of the portion to be segmented in the image to be segmented being related to shooting angle information of an image shooting apparatus. For example, in the case of the portion to be segmented is the floor portion, when the shooting angle information is elevation 90 degrees, the image to be segmented may be considered as having no floor portion. Therefore, after performing image fusion on the preliminarily segmented image and the target normal vector image, adjustment processing is performed on the image:
obtaining the shooting angle information of the image shooting apparatus for shooting the image to be segmented, and adjusting the target segmented image based on the shooting angle information.

The image shooting apparatus may be an apparatus for shooting the image to be segmented, such as a smart phone, a video camera, and a digital camera. The shooting angle information may be elevation information of the image shooting apparatus when shooting the image to be segmented. The shooting angle information may be measured by an inertial measurement unit (IMU).

Exemplarily, the shooting angle information when shooting the image to be segmented may be obtained based on the IMU in the image shooting apparatus. Whether the target segmented image includes the portion to be segmented is determined based on the shooting angle information, and the target segmented image is processed based on a determination result to obtain the final target segmented image. If it is determined that the target segmented image does not include the portion to be segmented based on the shooting angle information, each pixel in the target segmented image may be set to zero, and the image set to zero may be taken as the final target segmented image. If it is determined that the target segmented image includes the portion to be segmented based on the shooting angle information, the target segmented image may be taken as the final target segmented image.

Exemplarily, when the portion to be segmented in the image to be segmented is the floor, if the shooting angle information is 30 degrees to 90 degrees, each pixel in the target segmented image is set to zero, and if the shooting angle information is other angles, the pixel value of each pixel in the target segmented image is maintained.

According to the technical solution of this embodiment of the present disclosure, by obtaining the image to be segmented, determining the preliminarily segmented image and the target normal vector image that are corresponding to the image to be segmented, and performing image fusion on the preliminarily segmented image and the target normal vector image to obtain the target segmented image, the problems of poor accuracy and stability of image segmentation are solved, and the technical effect of improving the accuracy and stability of image segmentation is achieved.

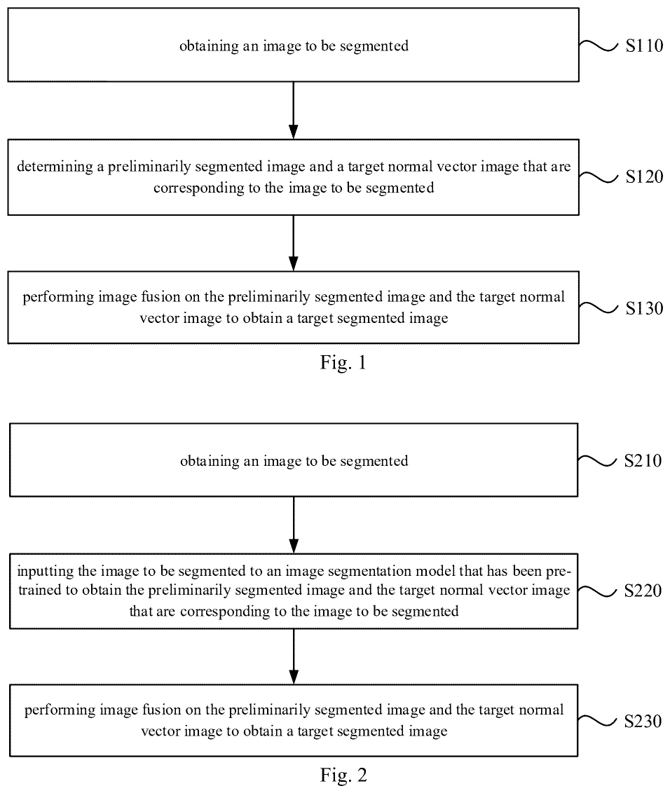

FIG. 2 is a flowchart of another image segmentation method provided by an embodiment of the present disclosure. On the basis of the foregoing technical solution, an implementation of determining the preliminarily segmented image and the target normal vector image that are corresponding to the image to be segmented may be as set forth in detail as in the present technical solution. The explanations of the terms the same as or equivalent to those in the above technical solutions will not be described here repeatedly.

As shown in FIG. 2, the method includes:

S210: obtaining an image to be segmented.

S220: inputting the image to be segmented to an image segmentation model that has been pre-trained to obtain the preliminarily segmented image and the target normal vector image that are corresponding to the image to be segmented.

The image segmentation model is trained based on a sample segmented image, a segmentation marked image corresponding to the sample segmented image, and a sample normal vector image corresponding to the sample segmented image. The image segmentation model is configured to process an image to obtain a preliminarily extracted segmented image and a normal vector image.

Exemplarily, the image to be segmented is input to the image segmentation model that has been pre-trained. The image to be segmented is processed by the image segmentation model that has been pre-trained, and an output result of the image segmentation model is determined as the preliminarily segmented image and the target normal vector image that are corresponding to the image to be segmented.

Before using the image segmentation model that has been pre-trained, the image segmentation model may be trained, which may include, for example, the following steps.

Step 1, with the sample segmented image as an input image to a big model that has been pre-established, and with the segmentation marked image and the sample normal vector image that are corresponding to the sample segmented image as expected output images of the big model, training the big model to obtain a teacher model.

The big model that has been pre-established may be an initial model for obtaining a segmented image and a normal vector image by meticulous processing, and may be a model of which a model structure and a model parameter are set by default. The big model that has been pre-established may be deeplab v3 (a semantic segmentation network) or the like. The sample segmented image may be a sample image including a portion to be segmented. The segmentation marked image may be an image in which a portion to be segmented is marked. The sample normal vector image may be an image composed of a normal vector of each pixel in the sample segmented image. The teacher model may be a model obtained by training the big model that has been pre-established.

Exemplarily, a big model is pre-established; and the sample segmented image is taken as an input image to the big model, and the segmentation marked image and the sample normal vector image that are corresponding to the sample segmented image are taken as the expected output images of the big model. The big model may be trained based on the input image and the expected output images, and the trained big model is taken as the teacher model.

Optionally, the big model that has been pre-established may be trained in the following way to obtain the teacher model.
1. The sample segmented image is input to the big model that has been pre-established to obtain a big model segmented image and a big model normal vector image.

The big model segmented image may be a segmented image output by the big model. The big model normal vector image may be a normal vector image output by the big model.

Exemplarily, the sample segmented image is input to the big model that has been pre-established, and the big model processes the sample segmented image. The segmented image of the output images is taken as the big model segmented image and the normal vector image of the output images is taken as the big model normal vector image.
2. A big model segmentation loss between the big model segmented image and the segmentation marked image corresponding to the sample segmented image is calculated, and a big model normal vector loss between the big model normal vector image and the sample normal vector image corresponding to the sample segmented image is calculated.

The big model segmentation loss may be a loss value between the big model segmented image and the segmentation marked image corresponding to the sample segmented image that is calculated based on a preset loss function. The big model normal vector loss may be a loss value between the big model normal vector image and the sample normal vector image that is calculated based on a preset loss function. Two loss functions may be the same or different. The loss function may be selected in practical use.

Optionally, the big model segmentation loss may be calculated based on any of the following loss functions.

A first way: calculating the big model segmentation loss between the big model segmented image and the segmentation marked image corresponding to the sample segmented image according to a binary cross entropy loss function.

Exemplarily, a loss value between the big model segmented image and the segmentation marked image corresponding to the sample segmented image is calculated based on the binary cross entropy loss function (BCE Loss), i.e., the big model segmentation loss.

A second way: calculating the big model segmentation loss between the big model segmented image and the segmentation marked image corresponding to the sample segmented image according to the binary cross entropy loss function and a regional mutual information loss function.

Exemplarily, a first loss value between the big model segmented image and the segmentation marked image corresponding to the sample segmented image is calculated based on the BCE Loss, and a second loss value between the big model segmented image and the segmentation marked image corresponding to the sample segmented image is calculated based on the regional mutual information loss function (RMI Loss). The big model segmentation loss may be obtained by processing based on the first loss value and the second loss value. The processing way may be summing, weighting, etc., which may be determined according to an actual situation.

Optionally, the big model normal vector loss may be calculated based on a loss function as follows:

The big model normal vector loss between the big model normal vector image and the sample normal vector image corresponding to the sample segmented image is calculated according to a mean square error loss function.

Exemplarily, a loss value between the big model normal vector image and the sample normal vector image corresponding to the sample segmented image is calculated based on the mean square error loss function (MSE Loss), i.e., the big model normal vector loss.
3. A model parameter of the big model is adjusted based on the big model segmentation loss and the big model normal vector loss to obtain the teacher model.

Exemplarily, the model parameter of the big model is adjusted based on the big model segmentation loss and the big model normal vector loss. When the loss functions of the big model all converge, e.g., when the big model segmentation loss and the big model normal vector loss are both less than a preset error or an error variation trend tends to be stable, or when a current number of iterations reaches a preset number, it may be considered that the effect of the big model has been able to meet a use requirement. At this time, model training is stopped, and the current big model is taken as the teacher model.

Step 2: with the sample segmented image as an input image to a small model that has been pre-established, and with a big model segmented image and a big model normal vector image that are corresponding to the sample segmented image and are output by the teacher model as expected outputs of the small model, training the small model to obtain the image segmentation model.

The small model that has been pre-established may be an initial model for obtaining a segmented image and a normal vector image by rough processing, and may be a model of which a model structure and a model parameter are set by default. The structure of the small model is simpler than that of the big model. The small model that has been pre-established may be ghostnet (a lightweight neutral network) or the like.

Exemplarily, a small model is pre-established; and the sample segmented image is taken as an input image to the small model, the big model segmented image and the big model normal vector image, which are corresponding to the sample segmented image and are output by the teacher model, are taken as the expected outputs of the small model.

The small model may be trained based on the input image and the expected output images, and the trained small model is taken as the image segmentation model.

Optionally, the small model that has been pre-established may be trained in the following way to obtain the image segmentation model.
1. The sample segmented image is input to the small model that has been pre-established as an input image to obtain a small model segmented image and a small model normal vector image.

The small model segmented image may be a segmented image output by the small model. The small model normal vector image may be a normal vector image output by the small model.

Exemplarily, the sample segmented image is input to the small model that has been pre-established, and the small model processes the sample segmented image. The segmented image of the output images is taken as the small model segmented image and the normal vector image of the output images is taken as the small model normal vector image.
2. A small model segmentation output loss is calculated based on the small model segmented image of the sample segmented image, the segmentation marked image, and the big model segmented image output by the teacher model.

The small model segmentation output loss may be a comprehensive loss value based on a loss value between the small model segmented image and the segmentation marked image corresponding to the sample segmented image, and a loss value between the small model segmented image and the big model segmented image output by the teacher model that are calculated based on preset loss functions. Two loss functions may be the same or different. The loss function may be selected in practical use.

Exemplarily, the loss value between the small model segmented image and the segmentation marked image, and the loss value between the small model segmented image and the big model segmented image are calculated separately. After the two loss values are obtained, the small model segmentation output loss is comprehensively determined.

Optionally, the small model segmentation output loss may be calculated in the following way.

A first small model segmentation loss between the small model segmented image of the sample segmented image and the segmentation marked image is calculated according to the binary cross entropy loss function, or the binary cross entropy loss function and a regional mutual information loss function.

The first small model segmentation loss may be a loss value between the small model segmented image of the sample segmented image and the segmentation marked image.

Exemplarily, a loss value between the small model segmented image and the segmentation marked image corresponding to the sample segmented image may be calculated based on the BCE Loss, i.e., the first small model segmentation loss. Alternatively, a first loss value between the small model segmented image and the segmentation marked image corresponding to the sample segmented image is calculated based on the BCE Loss, and a second loss value between the small model segmented image and the segmentation marked image corresponding to the sample segmented image is calculated based on the RMI Loss. The first small model segmentation loss may be obtained by processing based on the first loss value and the second loss value. The processing way may be summing, weighting, etc., which may be determined according to an actual situation.

A second small model segmentation loss between the small model segmented image and the big model segmented image output by the teacher model is calculated according to a kullback-leibler divergence loss function.

The second small model segmentation loss may be a loss value between the small model segmented image and the big model segmented image output by the teacher model.

Exemplarily, the loss value between the small model segmented image and the big model segmented image output by the teacher model is calculated based on the kullback-leibler divergence loss function (KL Loss), i.e., the second small model segmentation loss.

The small model segmentation output loss is determined based on the first small model segmentation loss and the second small model segmentation loss.

Exemplarily, the first small model segmentation loss and the second small model segmentation loss may be processed to obtain the small model segmentation output loss. The processing way may be summing, weighting, etc., which may be determined according to an actual situation.
3. A small model normal vector output loss is calculated based on the small model normal vector image of the sample segmented image, the sample normal vector image, and the big model normal vector image output by the teacher model.

Exemplarily, a loss value between the small model normal vector image and the sample normal vector image, and a loss value between the small model normal vector image and the big model normal vector image are calculated separately. After the two loss values are obtained, the small model normal vector output loss is comprehensively determined.

Optionally, the small model normal vector output loss may be calculated in the following way.

A first small model normal vector loss between the small model normal vector image of the sample segmented image and the sample normal vector image is calculated according to a mean square error loss function.

The first small model normal vector loss may be a loss value between the small model normal vector image and the sample normal vector image.

Exemplarily, the loss value between the small model normal vector image of the sample segmented image and the sample normal vector image is calculated based on the MSE Loss, i.e., the first small model normal vector loss.

A second small model normal vector loss between the small model normal vector image and the big model normal vector image output by the teacher model is calculated according to the kullback-leibler divergence loss function.

The second small model normal vector loss may be a loss value between the small model normal vector image and the big model normal vector image output by the teacher model.

Exemplarily, the loss value between the small model normal vector image and the big model normal vector image output by the teacher model is calculated based on the KL Loss, i.e., the second small model normal vector loss.

The small model normal vector output loss is determined based on the first small model normal vector loss and the second small model normal vector loss.

Exemplarily, the first small model normal vector loss and the second small model normal vector loss may be processed to obtain the small model normal vector output loss. The processing way may be summing, weighting, etc., which may be determined according to an actual situation.
4. A model parameter of the small model is adjusted based on the small model segmentation output loss and the small model normal vector output loss to obtain the image segmentation model.

Exemplarily, the model parameter of the small model is adjusted based on the small model segmentation output loss and the small model normal vector output loss. When the loss functions of the small model all converge, e.g., when the small model segmentation output loss and the small model normal vector output loss are both less than a preset error or an error variation trend tends to be stable, or when a current number of iterations reaches a preset number, it may be considered that the effect of the small model has been able to meet a use requirement. At this time, model training is stopped, and the current small model is taken as the image segmentation model.

S230: performing image fusion on the preliminarily segmented image and the target normal vector image to obtain a target segmented image.

According to the technical solution of the embodiment of the present disclosure, by obtaining the image to be segmented, inputting the image to be segmented to the image segmentation model that has been pre-trained to obtain the preliminarily segmented image and the target normal vector image that are corresponding to the image to be segmented such that the suitable preliminarily segmented image and the target normal vector image are obtained by processing using the image segmentation model, and performing image fusion on the preliminarily segmented image and the target normal vector image to obtain the target segmented image, the problems of poor accuracy and stability of image segmentation are solved, and the technical effect of improving the accuracy and stability of image segmentation is achieved.

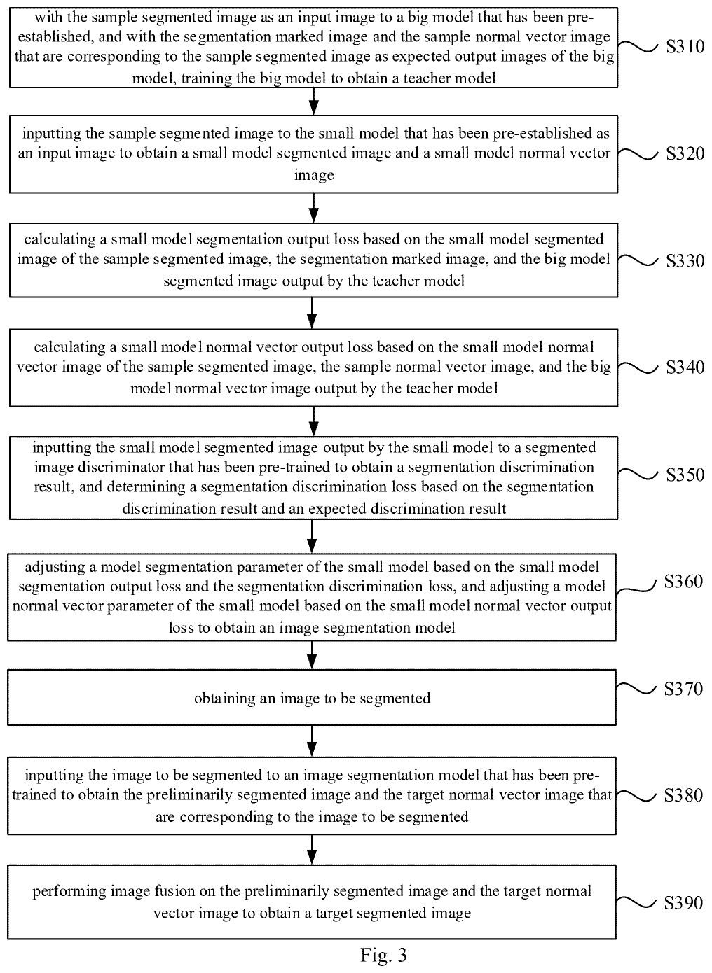

FIG. 3 is a flowchart of another image segmentation method provided by an embodiment of the present disclosure. On the basis of the foregoing technical solutions, a segmented image discriminator is added to discriminate the small model segmented image and the big model segmented image. A specific implementation may be as set forth in detail as in the present technical solution. The explanations of the terms the same as or equivalent to those in the above technical solutions will not be described here repeatedly.

As shown in FIG. 3, the method includes:

S310: with the sample segmented image as an input image to a big model that has been pre-established, and with the segmentation marked image and the sample normal vector image that are corresponding to the sample segmented image as expected output images of the big model, training the big model to obtain a teacher model.

S320, inputting the sample segmented image to the small model that has been pre-established as an input image to obtain a small model segmented image and a small model normal vector image.

S330: calculating a small model segmentation output loss based on the small model segmented image of the sample segmented image, the segmentation marked image, and the big model segmented image output by the teacher model.

S340: calculating a small model normal vector output loss based on the small model normal vector image of the sample segmented image, the sample normal vector image, and the big model normal vector image output by the teacher model.

S350: inputting the small model segmented image output by the small model to a segmented image discriminator that has been pre-trained to obtain a segmentation discrimination result, and determining a segmentation discrimination loss based on the segmentation discrimination result and an expected discrimination result.

The segmented image discriminator is trained with the big model segmented image corresponding to the sample segmented image output by the teacher model as a real sample and the small model segmented image output by the small model as a fake sample. The segmentation discrimination result may be a result output by the segmented image discriminator. The expected discrimination result may be an expected result output by the segmented image discriminator. Usually, the expected discrimination result is that the small big segmented image is identified as the real sample when the big model segmented image and the small model segmented image cannot be distinguished. The segmentation discrimination loss may be a loss value calculated based on a preset loss function in the segmented image discriminator. The preset loss function in the segmented image discriminator may be one or more of L1 loss (absolute error), L2 loss (square error), cross entropy error, and KL divergence (Kullback-Leibler Divergence, a measure index used to measure a similarity of two probability distributions).

Exemplarily, the small model segmented image output by the small model is input to the segmented image discriminator that has been pre-trained to obtain the segmentation discrimination result. The segmentation discrimination loss of the segmented image discriminator may be then calculated based on the segmentation discrimination result and the expected discrimination result of the segmented image discriminator.

Exemplarily, adversarial training is performed with the small model segmented image output by the small model as fake and the big model segmented image output by the big model as real. Assuming that the segmented image discriminator is denoted as D, the small model denoted as G_s, the big model denoted as G_t, and the sample segmented image input to the big model and the small model as input, and letting MSE_loss(a,b) be (a-b)², the loss function loss_D of the segmented image discriminator may be in the following form:

$$loss\_D = 0.5 * MSE\_loss ( D ( G\_s ( input ) ) , 0 ) + 0.5 * MSE\_loss ( D ( G\_t ( input ) ) , 1 ) .$$

It needs to be noted that the small model is trained such that the generated small model segmented image is hoped to enable the output of the segmented image discriminator to be 1, and the purpose of mixing the false with the genuine is achieved. The segmented image discriminator may be trained such that the capability of discriminating true and false is improved. As the number of iterations of the model training increases, the small model and the segmented image discriminator learn in a mutual gaming process and finally reach an equilibrium point. That is, the small model can generate data that is very close to the big model segmented image, and the segmented image discriminator cannot discriminate true and false, and the final output is 0.5.

S360: adjusting a model segmentation parameter of the small model based on the small model segmentation output loss and the segmentation discrimination loss, and adjusting a model normal vector parameter of the small model based on the small model normal vector output loss to obtain an image segmentation model.

The model segmentation parameter may be a model parameter for generating a small model segmented image portion in the small model. The model normal vector parameter may be a model parameter for generating a small model normal vector image portion in the small model.

Exemplarily, the model segmentation parameter of the small model is adjusted based on the small model segmentation output loss and the segmentation discrimination loss, and the model normal vector parameter of the small model is adjusted based on the small model normal vector output loss. When the loss functions of the small model all converge, e.g., when the small model segmentation output loss is less than a preset error, when the small model normal vector output loss is less than a preset error, when the segmentation discrimination loss is greater than a preset error, when an error variation trend tends to be stable, or when a current number of iterations reaches a preset number, it may be considered that the effect of the small model has been able to meet a use requirement. At this time, model training is stopped, and the current small model is taken as the image segmentation model.

S370: obtaining an image to be segmented.

S380: inputting the image to be segmented to an image segmentation model that has been pre-trained to obtain the preliminarily segmented image and the target normal vector image that are corresponding to the image to be segmented.

S390: performing image fusion on the preliminarily segmented image and the target normal vector image to obtain a target segmented image.

According to the technical solution of the embodiment of the present disclosure, with the sample segmented image as the input image to the big model that has been pre-established and the segmentation marked image and the sample normal vector image that are corresponding to the sample segmented image as the expected output images of the big model, the big model is trained to obtain the teacher model. The sample segmented image is input to the small model that has been pre-established as the input image to obtain the small model segmented image and the small model normal vector image. The small model segmented output loss is calculated based on the small model segmented image of the sample segmented image, the segmentation marked image, and the big model segmented image output by the teacher model, and the small model normal vector output loss is calculated based on the small model normal vector image of the sample segmented image, the sample normal vector image, and the big model normal vector image output by the teacher model. The small model segmented image output by the small model is input to the segmented image discriminator that has been pre-trained to obtain the segmentation discrimination result, and the segmentation discrimination loss is determined based on the segmentation discrimination result and the expected discrimination result. The model segmentation parameter of the small model is adjusted based on the small model segmentation output loss and the segmentation discrimination loss, and the model normal vector parameter of the small model is adjusted based on the small model normal vector output loss to obtain the image segmentation model. Thus, the accuracy and stability of the image segmentation model can be improved by the calculation of a plurality of losses. Further, the image to be segmented is obtained and input to the image segmentation model that has been pre-trained to obtain the preliminarily segmented image and the target normal vector image that are corresponding to the image to be segmented. Image fusion is performed on the preliminarily segmented image and the target normal vector image to obtain the target segmented image. The problems of high complexity, poor accuracy and poor stability of the image segmentation model are solved, and the technical effects of improving the accuracy and stability of model segmentation and reducing the model complexity are achieved.

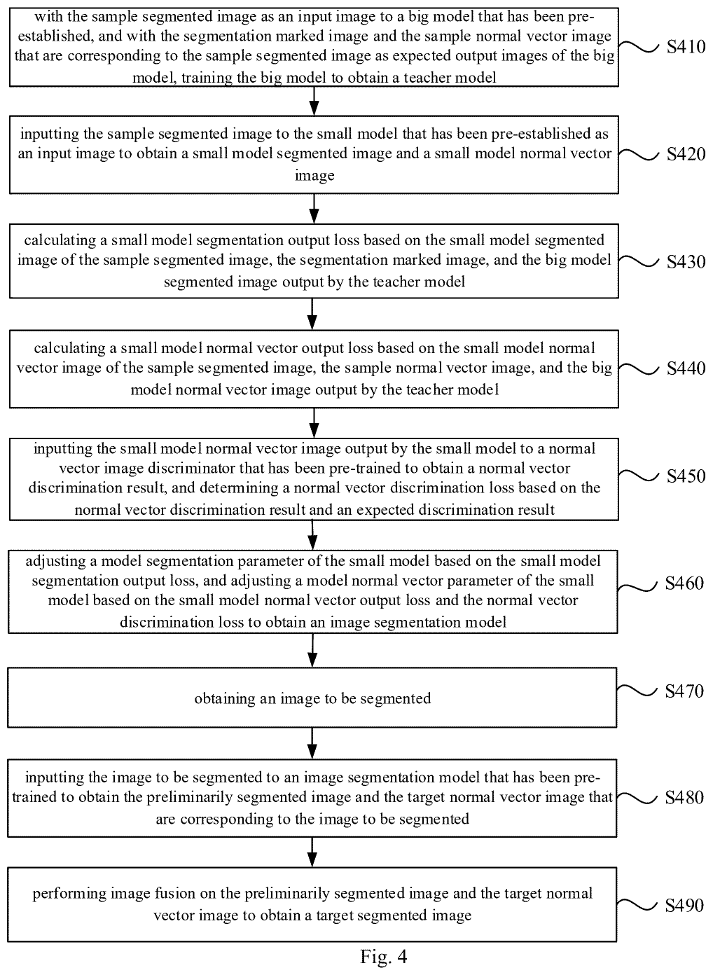

FIG. 4 is a flowchart of another image segmentation method provided by an embodiment of the present disclosure. On the basis of the foregoing technical solutions, a normal vector image discriminator is added to discriminate the small model normal vector image and the big model segmented image. A specific implementation may be as set forth in detail as in the present technical solution. The explanations of the terms the same as or equivalent to those in the above technical solutions will not be described here repeatedly.

As shown in FIG. 4, the method includes:

S410: with the sample segmented image as an input image to a big model that has been pre-established, and with the segmentation marked image and the sample normal vector image that are corresponding to the sample segmented image as expected output images of the big model, training the big model to obtain a teacher model.

S420: inputting the sample segmented image to the small model that has been pre-established as an input image to obtain a small model segmented image and a small model normal vector image.

S430: calculating a small model segmentation output loss based on the small model segmented image of the sample segmented image, the segmentation marked image, and the big model segmented image output by the teacher model.

S440: calculating a small model normal vector output loss based on the small model normal vector image of the sample segmented image, the sample normal vector image, and the big model normal vector image output by the teacher model.

S450: inputting the small model normal vector image output by the small model to a normal vector image discriminator that has been pre-trained to obtain a normal vector discrimination result, and determining a normal vector discrimination loss based on the normal vector discrimination result and an expected discrimination result.

The normal vector image discriminator is trained with the big model normal vector image corresponding to the sample segmented image output by the teacher model as a real sample and the small model normal vector image output by the small model as a fake sample. The normal vector discrimination result may be a result output by the normal vector image discriminator. The expected discrimination result may be an expected result output by the normal vector image discriminator. Usually, the expected discrimination result is that the small big normal vector image is identified as the real sample when the big model normal vector image and the small model normal vector image cannot be distinguished. The normal vector discrimination loss may be a loss value calculated based on a preset loss function in the normal vector image discriminator. The preset loss function in the normal vector image discriminator may be one or more of L1 loss, L2 loss, cross entropy error, and KL divergence.

Exemplarily, the small model normal vector image output by the small model is input to the normal vector image discriminator that has been pre-trained to obtain the normal vector discrimination result. The normal vector discrimination loss of the normal vector image discriminator may be then calculated based on the normal vector discrimination result and the expected discrimination result of the normal vector image discriminator.

It needs to be noted that the working principle of the normal vector image discriminator involved in S450 is similar to the working principle of the segmented image discriminator involved in S350, which will not be described redundantly here.

S460: adjusting a model segmentation parameter of the small model based on the small model segmentation output loss, and adjusting a model normal vector parameter of the small model based on the small model normal vector output loss and the normal vector discrimination loss to obtain an image segmentation model.

Exemplarily, the model segmentation parameter of the small model is adjusted based on the small model segmentation output loss, and the model normal vector parameter of the small model is adjusted based on the small model normal vector output loss and the normal vector discrimination loss. When the loss functions of the small model all converge, e.g., when the small model segmentation output loss is less than a preset error, when the small model normal vector output loss is less than a preset error, when the normal vector discrimination loss is greater than a preset error, when an error variation trend tends to be stable, or when a current number of iterations reaches a preset number, it may be considered that the effect of the small model has been able to meet a use requirement. At this time, model training is stopped, and the current small model is taken as the image segmentation model.

S470: obtaining an image to be segmented.

S480: inputting the image to be segmented to an image segmentation model that has been pre-trained to obtain the preliminarily segmented image and the target normal vector image that are corresponding to the image to be segmented.

S490: performing image fusion on the preliminarily segmented image and the target normal vector image to obtain a target segmented image.

It needs to be noted that the segmented image discriminator that has been pre-trained and the normal vector image discriminator that has been pre-trained may be used in combination to adjust the model segmentation parameter and the model normal vector parameter of the small model.

According to the technical solution of the embodiment of the present disclosure, with the sample segmented image as the input image to the big model that has been pre-established and the segmentation marked image and the sample normal vector image that are corresponding to the sample segmented image as the expected output images of the big model, the big model is trained to obtain the teacher model. The sample segmented image is input to the small model that has been pre-established as the input image to obtain the small model segmented image and the small model normal vector image. The small model segmented output loss is calculated based on the small model segmented image of the sample segmented image, the segmentation marked image, and the big model segmented image output by the teacher model, and the small model normal vector output loss is calculated based on the small model normal vector image of the sample segmented image, the sample normal vector image, and the big model normal vector image output by the teacher model. The small model normal vector image output by the small model is input to the normal vector image discriminator that has been pre-trained to obtain the normal vector discrimination result, and the normal vector discrimination loss is determined based on the normal vector discrimination result and the expected discrimination result. The model segmentation parameter of the small model is adjusted based on the small model segmentation output loss, and the model normal vector parameter of the small model is adjusted based on the small model normal vector output loss and the discrimination normal vector loss to obtain the image segmentation model. Thus, the accuracy and stability of the image segmentation model can be improved by the calculation of a plurality of losses. Further, the image to be segmented is obtained and input to the image segmentation model that has been pre-trained to obtain the preliminarily segmented image and the target normal vector image that are corresponding to the image to be segmented. Image fusion is performed on the preliminarily segmented image and the target normal vector image to obtain the target segmented image. The problems of high complexity, poor accuracy and poor stability of the image segmentation model are solved, and the technical effects of improving the accuracy and stability of model segmentation and reducing the model complexity are achieved.

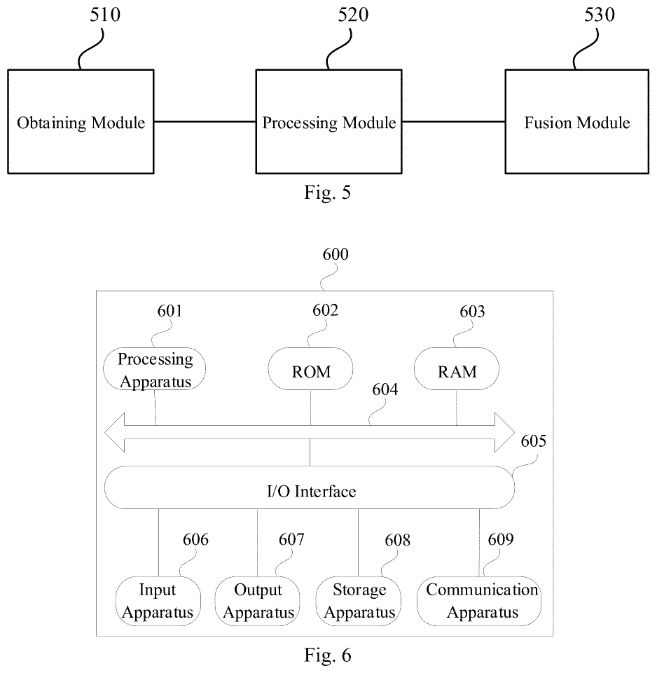

FIG. 5 is a structural schematic diagram of an image segmentation apparatus provided by an embodiment of the present disclosure. As shown in FIG. 5, the apparatus includes an obtaining module 510, a processing module 520, and a fusion module 530.

The obtaining module 510 is configured to obtain an image to be segmented; the processing module 520 is configured to determine a preliminarily segmented image and a target normal vector image that are corresponding to the image to be segmented; and the fusion module 530 is configured to perform image fusion on the preliminarily segmented image and the target normal vector image to obtain a target segmented image.

According to the technical solution of the embodiment of the present disclosure, by obtaining the image to be segmented, determining the preliminarily segmented image and the target normal vector image that are corresponding to the image to be segmented, and performing image fusion on the preliminarily segmented image and the target normal vector image to obtain the target segmented image, the problems of poor accuracy and stability of image segmentation are solved, and the technical effect of improving the accuracy and stability of image segmentation is achieved.

Optionally, the processing module 520 is configured to determine the preliminarily segmented image and the target normal vector image that are corresponding to the image to be segmented by: inputting the image to be segmented to an image segmentation model that has been pre-trained to obtain the preliminarily segmented image and the target normal vector image that are corresponding to the image to be segmented, where the image segmentation model is trained based on a sample segmented image, a segmentation marked image corresponding to the sample segmented image, and a sample normal vector image corresponding to the sample segmented image.

Optionally, the apparatus further includes a model training module configured to: with the sample segmented image as an input image to a big model that has been pre-established, and with the segmentation marked image and the sample normal vector image that are corresponding to the sample segmented image as expected output images of the big model, train the big model to obtain a teacher model; and with the sample segmented image as an input image to a small model that has been pre-established, and with a big model segmented image and a big model normal vector image that are corresponding to the sample segmented image and are output by the teacher model as expected outputs of the small model, train the small model to obtain the image segmentation model.

Optionally, the model training module is configured to obtain the teacher model by: inputting the sample segmented image to the big model that has been pre-established to obtain the big model segmented image and the big model normal vector image; calculating a big model segmentation loss between the big model segmented image and the segmentation marked image corresponding to the sample segmented image, and calculating a big model normal vector loss between the big model normal vector image and the sample normal vector image corresponding to the sample segmented image; and Adjusting a model parameter of the big model based on the big model segmentation loss and the big model normal vector loss to obtain the teacher model.

Optionally, the model training module is configured to calculate the big model segmentation loss by: calculating the big model segmentation loss between the big model segmented image and the segmentation marked image corresponding to the sample segmented image according to a binary cross entropy loss function; or calculating the big model segmentation loss between the big model segmented image and the segmentation marked image corresponding to the sample segmented image according to a binary cross entropy loss function and a regional mutual information loss function.

Optionally, the model training module is configured to calculate the big model normal vector loss by: calculating the big model normal vector loss between the big model normal vector image and the sample normal vector image corresponding to the sample segmented image according to a mean square error loss function.

Optionally, the model training module is configured to obtain the image segmentation model by: inputting the sample segmented image to the small model that has been pre-established as an input image to obtain a small model segmented image and a small model normal vector image; calculating a small model segmentation output loss based on the small model segmented image of the sample segmented image, the segmentation marked image, and the big model segmented image output by the teacher model; calculating a small model normal vector output loss based on the small model normal vector image of the sample segmented image, the sample normal vector image, and the big model normal vector image output by the teacher model; and adjusting a model parameter of the small model based on the small model segmentation output loss and the small model normal vector output loss to obtain the image segmentation model.

Optionally, the apparatus further includes a first discrimination module configured to: input the small model segmented image output by the small model to a segmented image discriminator that has been pre-trained to obtain a segmentation discrimination result, and determine a segmentation discrimination loss based on the segmentation discrimination result and an expected discrimination result, where the segmented image discriminator is trained with the big model segmented image corresponding to the sample segmented image output by the teacher model as a real sample and the small model segmented image output by the small model as a fake sample; and the model training module is configured to adjust the model parameter of the small model by: adjusting the model segmentation parameter of the small model based on the small model segmentation output loss and the segmentation discrimination loss; and adjusting a model normal vector parameter of the small model based on the small model normal vector output loss.

Optionally, the model training module is configured to calculate the small model segmentation output loss by: calculating a first small model segmentation loss between the small model segmented image of the sample segmented image and the segmentation marked image according to the binary cross entropy loss function, or the binary cross entropy loss function and a regional mutual information loss function; calculating a second small model segmentation loss between the small model segmented image and the big model segmented image output by the teacher model according to a kullback-leibler divergence loss function; and determining the small model segmentation output loss based on the first small model segmentation loss and the second small model segmentation loss.

Optionally, the model training module is configured to calculate the small model normal vector output loss by: calculating a first small model normal vector loss between the small model normal vector image of the sample segmented image and the sample normal vector image according to a mean square error loss function; calculating a second small model normal vector loss between the small model normal vector image and the big model normal vector image output by the teacher model according to the kullback-leibler divergence loss function; and determining the small model normal vector output loss based on the first small model normal vector loss and the second small model normal vector loss.

Optionally, the apparatus further includes a second determination module configured to: input the small model normal vector image output by the small model to a normal vector image discriminator that has been pre-trained to obtain a normal vector discrimination result, and determine a normal vector discrimination loss based on the normal vector discrimination result and an expected discrimination result, where the normal vector image discriminator is trained with the big model normal vector image corresponding to the sample segmented image output by the teacher model as a real sample and the small model normal vector image output by the small model as a fake sample; and the model training module is further configured to adjust the model parameter of the small model by: adjusting a model segmentation parameter of the small model based on the small model segmentation output loss; and adjusting a model normal vector parameter of the small model based on the small model normal vector output loss and the normal vector discrimination loss.

Optionally, the fusion module 530 is configured to obtain the target segmented image by: for each pixel in the preliminarily segmented image, determining a predicted weight of the pixel based on a predicted pixel value of the pixel in the target normal vector image and a preset segmentation threshold; weighting a pixel value of the pixel in the preliminarily segmented image based on the predicted weight to obtain a target pixel value of the pixel; and determining the target segmented image based on the target pixel value of each pixel in the preliminarily segmented image.

Optionally, the apparatus further includes an adjustment module configured to: obtain shooting angle information of an image shooting apparatus for shooting the image to be segmented, and adjust the target segmented image based on the shooting angle information.

The image segmentation apparatus provided in the embodiment of the present disclosure may perform the image segmentation method provided in any embodiment of the present disclosure and has corresponding functional modules for performing the method and corresponding beneficial effects.

It needs to be noted that the units and modules included in the apparatus described above are only divided according to functional logic, but are not limited to the above division, as long as corresponding functions can be implemented. In addition, names of the functional units are merely for the purpose of distinguishing from each other.

FIG. 6 is a structural schematic diagram of an electronic device provided by an embodiment of the present disclosure. Referring to FIG. 6, FIG. 6 illustrates a schematic structural diagram of an electronic device 600 (for example, the terminal device or server in FIG. 6) suitable for implementing the embodiments of the present disclosure. The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 6 is merely an example.

As illustrated in FIG. 6, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected through a bus 604. An input/output (I/O) interface 605 is also connected to the bus 604.

Usually, the following apparatuses may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 6 illustrates the electronic device 600 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

The electronic device provided in this embodiment of the present disclosure and the image segmentation method provided in the foregoing embodiments belong to the same inventive concept. For technical details not described in detail in the present embodiment, a reference may be made to the foregoing embodiments, and the present embodiment and the foregoing embodiments have the same beneficial effects.

An embodiment of the present disclosure provides a computer storage medium storing a computer which, when executed by a processor, causes implementing the image segmentation method provided in the foregoing embodiments.

It should be noted that the above-mentioned computer-readable medium in the present disclosure may be a computer-readable signal medium or a computer-readable storage medium or any combination thereof. For example, the computer-readable storage medium may be an electric, magnetic, optical, electromagnetic, infrared, or semiconductor system, apparatus or device, or any combination thereof. Examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries at least one program which, when executed by the electronic device, causes the electronic device to: obtain an image to be segmented; determine a preliminarily segmented image and a target normal vector image that are corresponding to the image to be segmented; and perform image fusion on the preliminarily segmented image and the target normal vector image to obtain a target segmented image.

The computer program code for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes an electrical, magnetic, optical, electromagnetic, infrared, or semi-conductive system, apparatus or device, or suitable combination of the foregoing. Examples of machine-readable storage medium include electrical connection with at least one wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or suitable combination of the foregoing.

According to one or more embodiments of the present disclosure, [example 1] provides an image segmentation method, including:
obtaining an image to be segmented;
determining a preliminarily segmented image and a target normal vector image that are corresponding to the image to be segmented; and
performing image fusion on the preliminarily segmented image and the target normal vector image to obtain a target segmented image.

According to one or more embodiments of the present disclosure, [example 2] provides an image segmentation method, further including:

Optionally, the determining the preliminarily segmented image and the target normal vector image that are corresponding to the image to be segmented includes:
inputting the image to be segmented to an image segmentation model that has been pre-trained to obtain the preliminarily segmented image and the target normal vector image that are corresponding to the image to be segmented, where the image segmentation model is trained based on a sample segmented image, a segmentation marked image corresponding to the sample segmented image, and a sample normal vector image corresponding to the sample segmented image.

According to one or more embodiments of the present disclosure, [example 3] provides an image segmentation method, further including:

Optionally, before the inputting the image to be segmented to the image segmentation model that has been pre-trained, the method further including:
with the sample segmented image as an input image to a big model that has been pre-established, and with the segmentation marked image and the sample normal vector image that are corresponding to the sample segmented image as expected output images of the big model, training the big model to obtain a teacher model; and
with the sample segmented image as an input image to a small model that has been pre-established, and with a big model segmented image and a big model normal vector image that are corresponding to the sample segmented image and are output by the teacher model as expected outputs of the small model, training the small model to obtain the image segmentation model.

According to one or more embodiments of the present disclosure, [example 4] provides an image segmentation method, further including:

Optionally, the with the sample segmented image as the input image to the big model that has been pre-established, and with the segmentation marked image and the sample normal vector image that are corresponding to the sample segmented image as expected output images of the big model, training the big model to obtain the teacher model includes:
inputting the sample segmented image to the big model that has been pre-established to obtain the big model segmented image and the big model normal vector image;
calculating a big model segmentation loss between the big model segmented image and the segmentation marked image corresponding to the sample segmented image, and calculating a big model normal vector loss between the big model normal vector image and the sample normal vector image corresponding to the sample segmented image; and
adjusting a model parameter of the big model based on the big model segmentation loss and the big model normal vector loss to obtain the teacher model.

According to one or more embodiments of the present disclosure, [example 5] provides an image segmentation method, further including:

Optionally, the calculating the big model segmentation loss between the big model segmented image and the segmentation marked image corresponding to the sample segmented image includes:
calculating the big model segmentation loss between the big model segmented image and the segmentation marked image corresponding to the sample segmented image according to a binary cross entropy loss function; or
calculating the big model segmentation loss between the big model segmented image and the segmentation marked image corresponding to the sample segmented image according to the binary cross entropy loss function and a regional mutual information loss function.

According to one or more embodiments of the present disclosure, [example 6] provides an image segmentation method, further including:

Optionally, the calculating the big model normal vector loss between the big model normal vector image and the sample normal vector image corresponding to the sample segmented image includes:
calculating the big model normal vector loss between the big model normal vector image and the sample normal vector image corresponding to the sample segmented image according to a mean square error loss function.

According to one or more embodiments of the present disclosure, [example 7] provides an image segmentation method, further including:

Optionally, the with the sample segmented image as the input image to the small model that has been pre-established, and with the big model segmented image and the big model normal vector image that are corresponding to the sample segmented image and are output by the teacher model as expected outputs of the small model, training the small model includes:
inputting the sample segmented image to the small model that has been pre-established as an input image to obtain a small model segmented image and a small model normal vector image;
calculating a small model segmentation output loss based on the small model segmented image of the sample segmented image, the segmentation marked image, and the big model segmented image output by the teacher model;
calculating a small model normal vector output loss based on the small model normal vector image of the sample segmented image, the sample normal vector image, and the big model normal vector image output by the teacher model; and
adjusting a model parameter of the small model based on the small model segmentation output loss and the small model normal vector output loss to obtain the image segmentation model.

According to one or more embodiments of the present disclosure, [example 8] provides an image segmentation method, further including:

Optionally, the method further including:
inputting the small model segmented image output by the small model to a segmented image discriminator that has been pre-trained to obtain a segmentation discrimination result, and determining a segmentation discrimination loss based on the segmentation discrimination result and an expected discrimination result, where the segmented image discriminator is trained with the big model segmented image corresponding to the sample segmented image output by the teacher model as a real sample and the small model segmented image output by the small model as a fake sample; and
the adjusting the model parameter of the small model based on the small model segmentation output loss and the small model normal vector output loss includes:
adjusting a model segmentation parameter of the small model based on the small model segmentation output loss and the segmentation discrimination loss; and
adjusting a model normal vector parameter of the small model based on the small model normal vector output loss.

According to one or more embodiments of the present disclosure, [example 9] provides an image segmentation method, further including:

Optionally, the calculating the small model segmentation output loss based on the small model segmented image of the sample segmented image, the segmentation marked image, and the big model segmented image output by the teacher model includes:
calculating a first small model segmentation loss between the small model segmented image of the sample segmented image and the segmentation marked image according to a binary cross entropy loss function, or the binary cross entropy loss function and a regional mutual information loss function;
calculating a second small model segmentation loss between the small model segmented image and the big model segmented image output by the teacher model according to a kullback-leibler divergence loss function; and
determining the small model segmentation output loss based on the first small model segmentation loss and the second small model segmentation loss.

According to one or more embodiments of the present disclosure, [example 10] provides an image segmentation method, further including:

Optionally, the calculating the small model normal vector output loss based on the small model normal vector image of the sample segmented image, the sample normal vector image, and the big model normal vector image output by the teacher model includes:
calculating a first small model normal vector loss between the small model normal vector image of the sample segmented image and the sample normal vector image according to a mean square error loss function;
calculating a second small model normal vector loss between the small model normal vector image and the big model normal vector image output by the teacher model according to a kullback-leibler divergence loss function; and
determining the small model normal vector output loss based on the first small model normal vector loss and the second small model normal vector loss.

According to one or more embodiments of the present disclosure, [example 11] provides an image segmentation method, further including:

Optionally, the method further including:
inputting the small model normal vector image output by the small model to a normal vector image discriminator that has been pre-trained to obtain a normal vector discrimination result, and determining a normal vector discrimination loss based on the normal vector discrimination result and an expected discrimination result, where the normal vector image discriminator is trained with the big model normal vector image corresponding to the sample segmented image output by the teacher model as a real sample and the small model normal vector image output by the small model as a fake sample; and
the adjusting the model parameter of the small model based on the small model segmentation output loss and the small model normal vector output loss includes:
adjusting a model segmentation parameter of the small model based on the small model segmentation output loss; and
adjusting a model normal vector parameter of the small model based on the small model normal vector output loss and the normal vector discrimination loss.

According to one or more embodiments of the present disclosure, [example 12] provides an image segmentation method, further including:

Optionally, the performing image fusion on the preliminarily segmented image and the target normal vector image to obtain the target segmented image includes:
for each pixel in the preliminarily segmented image, determining a predicted weight of the pixel based on a predicted pixel value of the pixel in the target normal vector image, and a preset segmentation threshold;
weighting a pixel value of the pixel in the preliminarily segmented image based on the predicted weight to obtain a target pixel value of the pixel; and
determining the target segmented image based on the target pixel value of each pixel in the preliminarily segmented image.

According to one or more embodiments of the present disclosure, [example 13] provides an image segmentation method, further including:

Optionally, after the performing image fusion on the preliminarily segmented image and the target normal vector image, the method further including:
obtaining shooting angle information of an image shooting apparatus for shooting the image to be segmented, and adjusting the target segmented image based on the shooting angle information.

1 According to one or more embodiments of the present disclosure, [example 14] provides an image segmentation apparatus, including:
an obtaining module, configured to obtain an image to be segmented;
a processing module, configured to determine a preliminarily segmented image and a target normal vector image that are corresponding to the image to be segmented; and
a fusion module, configured to perform image fusion on the preliminarily segmented image and the target normal vector image to obtain a target segmented image.

1. An image segmentation method, comprising:
obtaining an image to be segmented;
determining a preliminarily segmented image and a target normal vector image that are corresponding to the image to be segmented; and
performing image fusion on the preliminarily segmented image and the target normal vector image to obtain a target segmented image.

2. The method according to claim 1, wherein the determining the preliminarily segmented image and the target normal vector image that are corresponding to the image to be segmented comprises:
inputting the image to be segmented to an image segmentation model that has been pre-trained to obtain the preliminarily segmented image and the target normal vector image that are corresponding to the image to be segmented, wherein the image segmentation model is trained based on a sample segmented image, a segmentation marked image corresponding to the sample segmented image, and a sample normal vector image corresponding to the sample segmented image.

3. The method according to claim 2, before the inputting the image to be segmented to the image segmentation model that has been pre-trained, further comprising:
with the sample segmented image as an input image to a big model that has been pre-established, and with the segmentation marked image and the sample normal vector image that are corresponding to the sample segmented image as expected output images of the big model, training the big model to obtain a teacher model; and
with the sample segmented image as an input image to a small model that has been pre-established, and with a big model segmented image and a big model normal vector image that are corresponding to the sample segmented image and are output by the teacher model as expected outputs of the small model, training the small model to obtain the image segmentation model.

4. The method according to claim 3, wherein the training the big model to obtain the teacher model comprises:
inputting the sample segmented image to the big model that has been pre-established to obtain the big model segmented image and the big model normal vector image;
calculating a big model segmentation loss between the big model segmented image and the segmentation marked image corresponding to the sample segmented image, and calculating a big model normal vector loss between the big model normal vector image and the sample normal vector image corresponding to the sample segmented image; and
adjusting a model parameter of the big model based on the big model segmentation loss and the big model normal vector loss to obtain the teacher model.

5. The method according to claim 4, wherein the calculating the big model segmentation loss between the big model segmented image and the segmentation marked image corresponding to the sample segmented image comprises:
calculating the big model segmentation loss between the big model segmented image and the segmentation marked image corresponding to the sample segmented image according to a binary cross entropy loss function; or
calculating the big model segmentation loss between the big model segmented image and the segmentation marked image corresponding to the sample segmented image according to the binary cross entropy loss function and a regional mutual information loss function.

6. The method according to claim 4, wherein the calculating the big model normal vector loss between the big model normal vector image and the sample normal vector image corresponding to the sample segmented image comprises:
calculating the big model normal vector loss between the big model normal vector image and the sample normal vector image corresponding to the sample segmented image according to a mean square error loss function.

7. The method according to claim 3, wherein the training the small model comprises:
inputting the sample segmented image to the small model that has been pre-established as an input image to obtain a small model segmented image and a small model normal vector image;
calculating a small model segmentation output loss based on the small model segmented image of the sample segmented image, the segmentation marked image, and the big model segmented image output by the teacher model;
calculating a small model normal vector output loss based on the small model normal vector image of the sample segmented image, the sample normal vector image, and the big model normal vector image output by the teacher model; and
adjusting a model parameter of the small model based on the small model segmentation output loss and the small model normal vector output loss to obtain the image segmentation model.

8. The method according to claim 7, further comprising:
inputting the small model segmented image output by the small model to a segmented image discriminator that has been pre-trained to obtain a segmentation discrimination result, and determining a segmentation discrimination loss based on the segmentation discrimination result and an expected discrimination result, wherein the segmented image discriminator is trained with the big model segmented image corresponding to the sample segmented image output by the teacher model as a real sample and the small model segmented image output by the small model as a fake sample; and
the adjusting the model parameter of the small model based on the small model segmentation output loss and the small model normal vector output loss comprises:
adjusting a model segmentation parameter of the small model based on the small model segmentation output loss and the segmentation discrimination loss; and
adjusting a model normal vector parameter of the small model based on the small model normal vector output loss.

9. The method according to claim 7, wherein the calculating the small model segmentation output loss based on the small model segmented image of the sample segmented image, the segmentation marked image, and the big model segmented image output by the teacher model comprises:
calculating a first small model segmentation loss between the small model segmented image of the sample segmented image and the segmentation marked image according to a binary cross entropy loss function, or the binary cross entropy loss function and a regional mutual information loss function;
calculating a second small model segmentation loss between the small model segmented image and the big model segmented image output by the teacher model according to a kullback-leibler divergence loss function; and
determining the small model segmentation output loss based on the first small model segmentation loss and the second small model segmentation loss.

10. The method according to claim 7, wherein the calculating the small model normal vector output loss based on the small model normal vector image of the sample segmented image, the sample normal vector image, and the big model normal vector image output by the teacher model comprises:
calculating a first small model normal vector loss between the small model normal vector image of the sample segmented image and the sample normal vector image according to a mean square error loss function;
calculating a second small model normal vector loss between the small model normal vector image and the big model normal vector image output by the teacher model according to a kullback-leibler divergence loss function; and
determining the small model normal vector output loss based on the first small model normal vector loss and the second small model normal vector loss.

11. The method according to claim 7, further comprising:
inputting the small model normal vector image output by the small model to a normal vector image discriminator that has been pre-trained to obtain a normal vector discrimination result, and determining a normal vector discrimination loss based on the normal vector discrimination result and an expected discrimination result, wherein the normal vector image discriminator is trained with the big model normal vector image corresponding to the sample segmented image output by the teacher model as a real sample and the small model normal vector image output by the small model as a fake sample; and
the adjusting the model parameter of the small model based on the small model segmentation output loss and the small model normal vector output loss comprises:
adjusting a model segmentation parameter of the small model based on the small model segmentation output loss; and
adjusting a model normal vector parameter of the small model based on the small model normal vector output loss and the normal vector discrimination loss.

12. The method according to claim 1, wherein the performing image fusion on the preliminarily segmented image and the target normal vector image to obtain the target segmented image comprises:
for each pixel in the preliminarily segmented image, determining a predicted weight of the pixel based on a predicted pixel value of the pixel in the target normal vector image, and a preset segmentation threshold;
weighting a pixel value of the pixel in the preliminarily segmented image based on the predicted weight to obtain a target pixel value of the pixel; and
determining the target segmented image based on the target pixel value of each pixel in the preliminarily segmented image.

13. The method according to claim 1, after the performing image fusion on the preliminarily segmented image and the target normal vector image, further comprising:
obtaining shooting angle information of an image shooting apparatus for shooting the image to be segmented, and adjusting the target segmented image based on the shooting angle information.

14. (canceled)

15. An electronic device, comprising:
a processor; and
a storage apparatus, configured to store a program,
wherein the program, when executed by the processor, causes the processor to implement-the an image segmentation method, wherein the method comprising:
obtaining an image to be segmented;
determining a preliminarily segmented image and a target normal vector image that are corresponding to the image to be segmented; and
performing image fusion on the preliminarily segmented image and the target normal vector image to obtain a target segmented image.

16. A storage medium comprising computer-executable instructions, wherein the computer-executable instructions, when executed by a computer processor, cause implementing the image segmentation method according to claim 1.

17. The electronic device according to claim 15, wherein the determining the preliminarily segmented image and the target normal vector image that are corresponding to the image to be segmented comprises:
inputting the image to be segmented to an image segmentation model that has been pre-trained to obtain the preliminarily segmented image and the target normal vector image that are corresponding to the image to be segmented, wherein the image segmentation model is trained based on a sample segmented image, a segmentation marked image corresponding to the sample segmented image, and a sample normal vector image corresponding to the sample segmented image.

18. The electronic device according to claim 17, before the inputting the image to be segmented to the image segmentation model that has been pre-trained, further comprising:
with the sample segmented image as an input image to a big model that has been pre-established, and with the segmentation marked image and the sample normal vector image that are corresponding to the sample segmented image as expected output images of the big model, training the big model to obtain a teacher model; and
with the sample segmented image as an input image to a small model that has been pre-established, and with a big model segmented image and a big model normal vector image that are corresponding to the sample segmented image and are output by the teacher model as expected outputs of the small model, training the small model to obtain the image segmentation model.

19. The electronic device according to claim 18, wherein the training the big model to obtain the teacher model comprises:
inputting the sample segmented image to the big model that has been pre-established to obtain the big model segmented image and the big model normal vector image;
calculating a big model segmentation loss between the big model segmented image and the segmentation marked image corresponding to the sample segmented image, and calculating a big model normal vector loss between the big model normal vector image and the sample normal vector image corresponding to the sample segmented image; and
adjusting a model parameter of the big model based on the big model segmentation loss and the big model normal vector loss to obtain the teacher model.

20. The electronic device according to claim 18, wherein the training the small model comprises:
inputting the sample segmented image to the small model that has been pre-established as an input image to obtain a small model segmented image and a small model normal vector image;
calculating a small model segmentation output loss based on the small model segmented image of the sample segmented image, the segmentation marked image, and the big model segmented image output by the teacher model;
calculating a small model normal vector output loss based on the small model normal vector image of the sample segmented image, the sample normal vector image, and the big model normal vector image output by the teacher model; and
adjusting a model parameter of the small model based on the small model segmentation output loss and the small model normal vector output loss to obtain the image segmentation model.

21. The electronic device according to claim 15, wherein the performing image fusion on the preliminarily segmented image and the target normal vector image to obtain the target segmented image comprises:
for each pixel in the preliminarily segmented image, determining a predicted weight of the pixel based on a predicted pixel value of the pixel in the target normal vector image, and a preset segmentation threshold;
weighting a pixel value of the pixel in the preliminarily segmented image based on the predicted weight to obtain a target pixel value of the pixel; and
determining the target segmented image based on the target pixel value of each pixel in the preliminarily segmented image.
